(19) United States
(12) Patent Application Publication
(10) Pub. No.: US 2022/0366418 A1
(43) Pub. Date: Nov. 17, 2022

(54) ACCESS CONTROL USING STAND-ALONE PARAMETERS FOR WIRELESS DEVICES

(71) Applicant: The Harvest Collective LLC (dba Shinepay), Oakland, CA (US)

(72) Inventor: George William MELCER, Oakland, CA (US)

(21) Appl. No.: 17/741,319

(22) Filed: May 10, 2022

Related U.S. Application Data
(60) Provisional application No. 63/189,390, filed on May 17, 2021.

(51) Int. Cl. G06Q 20/40; G06Q 20/32

(52) U.S. Cl. CPC G06Q 20/4014; G06Q 20/3276

(57) ABSTRACT

Aspects of a system and apparatus for accessing online services subject to limitations and restrictions are disclosed. An operator, also referenced herein as a vendor or subscriber, access a third party host server. The operator provides a plurality of data parameters describing a scope and extent of user privileges with respect to one or more services available to the server via a network or internet connection. A user may download an application and use the services, including providing funds through an account funded by the user where applicable. The user's access to the service at issue may be subject to the data parameters at the server, which may provide limitations or restriction on the use of the service by the server, or which, in appropriate cases, may deny service.

### BACKGROUND

### Field

This disclosure is generally related to wireless devices and more particularly to allocating access control to subscribers without the need for a hardware payment infrastructure.

### Introduction

Modern consumers regularly conduct transactions using credit cards. The use of smart phones and similar wireless devices to make purchases, however, has recently become ubiquitous. This trend is evident as platforms like Apple Pay and the like have enabled consumers to purchase goods with their phones, as well as to consummate purchases through vending machines and other automated services.

A present disadvantage with Apple Pay and similar platforms from the perspective of the vendor is that the vendor is required to purchase a separate near field communication (NFC) hardware payment terminal having a card reader at the point of sale (POS). The NFC reader is connected to the Internet such that the funds can be transferred and the payment settled, depending on the payment method chosen by the purchaser within the Apple Pay application's preferences.

To gain entry to a parking garage or elevator bay at a work facility, or to charge an electric vehicle, the same consumer may need one or more key fobs or access cards, which include their own internal hardware or magnetic encoding. These cards/fobs are commonly lost. The card ordinarily remains active until an administrator revokes access. In a parking lot in the basement of a commercial building, for example, wireless or cellular internet access is often not a viable option, in which case the owner must incur the cost of wiring the gate entry to provide a terrestrial Internet connection for a payment/access module.

A need persists in the art for a solution that overcomes these disparate challenges.

### SUMMARY

Aspects of the present disclosure allow subscribers access to services, which includes services or assets of any kind. Key fobs and access cards may be eliminated. Moreover, a costly hardware module for accessing the Internet by the subscriber during a payment is eliminated. A subscriber may establish an account with a host of a server. In turn, the host may review the service at issue, and may modify access to the service (e.g., a parking gate, laundry, vending machine, vehicle charging station, toll booth, etc.) to provide the operator with an access element which may include a code, such as a QR code, used for identifying the service by a user application and a simple Bluetooth connection service and an actuator for initiating a preexisting electric motor or other conventional access device.

In one aspect of the present disclosure, a system is described. The system includes a server coupled to a repository for storing data parameters provided by an operator. The server is networked for transferring data to remote locations. The system further includes a wireless device. The wireless device includes a memory and a processor configured to execute an application stored in the memory to enable a user to access a service. An allowable number of accesses, or time periods. or frequency of use of the service, is based on the data parameters. The processor is configured to retrieve a code from an access element provided by the operator. The access code is local to the service. The processor is further configured to transmit the code and a user identification (ID) to the server. The server is configured to compare the data parameters with the code and user ID. When the data parameters permit, the server is configured to transmit access data for forwarding to the access element by the wireless device. The wireless device is configured to use the access data to provide access to the service. The scope of service subject to the data parameters maintained in the repository.

In another aspect of the disclosure, a wireless device includes a memory and at least one processor coupled to the memory. The at least one processor is configured to execute instructions from an application stored in memory to provide a user interface (UI). The UI provides a user access to a service maintained by a third party, wherein access rights of the user are maintained based on data parameters provided by the third party and stored by an operator in a repository. The wireless device is further configured to transmit, via the UD to a remote server coupled to the repository, at least one message request access to the service and an identification thereof. The wireless device is further configured to receive, from the server, information including an authorization to access the service. The authorization may be subject to restrictions to access the service if the restrictions are present in the data parameters. The wireless device may enable the user to tender a payment from an account established using the application if the authorization is conditioned on payment. Based on the at least one of the authorization information or the payment confirmation, the wireless device may enable the user to access the service. The access element is local to the service and uses a single local network connection from the wireless device for actuating an access mechanism to the service.

In still another access of the disclosure, a non-transitory computer-readable medium stores computer executable code that, when executed by a processor of a wireless device, causes the processor to perform various functions. That is, the processor may provide a user interface (UI). The UI provides user access to a service maintained by a third party. Access rights of the user are maintained based on data parameters provided by the third party and stored by an operator in a repository. The wireless device may scan the device identification and may transmit, via the UI to a remote server coupled to the repository at least one message requesting access to the service. The at least one message may include the device identification and an identification of a user. The wireless device may thereupon receive a response from the server authorizing the user to access the server including any applicable restrictions. When one or more restrictions apply, the server may authorize the user access to the service subject to the restrictions via a local network transmission to an access element corresponding to the service such that the access element does not require an Internet connection.

It is understood that other aspects of the storage device will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of the present invention will now be presented in the detailed description by way of example, and not by way of limitation, with reference to the accompanying drawings, wherein:

FIG. 1 is a block diagram illustrating an exemplary embodiment of a server to which an operator has subscribed and an asset including an asset element provided by an operator for enabling a wireless device user to access a service with the assistance of an application loaded onto the wireless device from the server.

FIG. 2 is a block diagram which in this embodiment includes a QR code and a control module for providing data to a wireless device used for accessing a service via an access element.

FIG. 3 is a flow diagram illustrating techniques for accessing an asset by a subscriber based on data parameters provided by the operator of a service to the remote.

FIG. 4 is another embodiment of a flow diagram allowing a user to use a previously downloaded application to obtain offline access to a paid service in accordance with another embodiment.

FIG. 5 is an exemplary touch screen of operator-provided software for entering data parameters in accordance with an embodiment.

FIG. 6 is an exemplary touch screen of operator-provided software for entering data parameters in accordance with an embodiment.

FIG. 7 is a flow chart illustrating a method according to an embodiment.

FIG. 8 is a flow chart illustrating a method according to an embodiment.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The words “exemplary” and “example” are used herein to mean serving as an example, instance, or illustration. Any exemplary embodiment described herein as “exemplary” is not necessarily to be construed as preferred or advantageous over other exemplary embodiments. Likewise, the term “exemplary embodiment” of an apparatus, method or article of manufacture does not require that all exemplary embodiments of the invention include the described components, structure, features, functionality, processes, advantages, benefits, or modes of operation.

As used herein, the term “coupled” is used to indicate either a direct connection between two components or, where appropriate, an indirect connection to one another through intervening or intermediate components. In contrast, when a component referred to as being “directly coupled” to another component, there are no intervening elements present.

In the following detailed description, various aspects of a wireless device used to obtain access to a service are described without the need for a separate device to effect payment, such as in conventional methods. These aspects are well suited for use in services such as vending, laundry, electric vehicle charging, parking, gated access, and the like. However, those skilled in the art will realize that these aspects may be extended to all types of service (intended to include assets of various kinds such as detergent obtained using the principles herein from a laundry vending machine, other vending machine food and beverage articles, etc.), whether paid or unpaid access thereto is sought, and the service is provided according to criteria or data parameters set forth by the host or owner, referred to herein also as the operator. As such, any reference to a specific apparatus or method is intended only to illustrate the various aspects of the present invention, with the understanding that such aspects may have a wide range of applications without departing from the spirit and scope of the present disclosure.

Various aspects of a service, a wireless device, and a computer-readable medium relate to access control techniques disclosed herein that obviate the need for an independent component to tender payment on a vendor's behalf over the Internet. In one aspect of the disclosure, access control techniques may enable users of an existing wireless device to access various services sponsored by operators. For purposes of this disclosure, wireless devices may broadly refer to, for example a smart phone, a tablet, or other internet accessible device of a generally mobile, portable, or transportable nature. Wireless devices may also include mobile devices integrated within a vehicle or other moving or moveable object. In various embodiments, the wireless device can be used to download an application sponsored by a third party server operator. The application can be used thereafter in the wireless device to access a significant number of services.

As an illustration, the wireless device, such as a smart phone, can complete replace the key fobs and access cards ordinarily used by an individual to access a place of work or other secure area. To this end, the wireless device may include the downloaded application, which may be selectively configured by one or more operators. An operator may have a plurality of services. For example, the operator may be a security company that has been retained by various buildings in a given area to provide secure access to tenants of the building (e.g., employees or individuals renting an apartment). To initiate the process, the operator may contact the centralized third party. The third party may be an owner of a server computer coupled to a repository or database. The repository may be populated with data parameters that are provided at the outset of the process by the operator. The data parameters may be a set of data that identify individuals (e.g., by name and a unique number such as an employee number), which individuals may be authorized to access the service owned or overseen by the operator.

In various embodiments for different operators, access may be based on, and subject to, various limitations. For example, the operator may be a municipality, and the data parameters may identify whether the individual is a civilian vehicle owner, or a tenant of the facility, for example. The data parameters provided to the third party and stored in the repository may identify a plurality of electric vehicle chargers. The data parameters may further specify that tenants of the facility, or in the case where the operator is a municipality, government officials or police officers are entitled to obtain free electric vehicle charging services, whereas non-government officials, or simple civilian personnel may be required to pay for the vehicle charging services of the operator.

In the aforedescribed embodiments, the server operator may enter into a single financial arrangement with the operator for a single set of services. The server may be a computer, or a plurality of coupled computers, or high-capacity machines, that are coupled to the repository. The server may include a processing system, which in turn may include one or more CPUs and memory (e.g., dynamic random access memory (DRAM), static random access memory (SRAM), and non-volatile memory. The data repository may include a single large database (e.g., and array of hard drives or solid-state drives), or the repository may include a distributed database of memories located in different areas or regions, all without departing from the scope or spirit of the present disclosure.

In some embodiments, the services offered may be via vending machines for food and beverages, laundry machines, and the like. In other embodiments, parking, vehicle access, and self-serve car washes may be examples of services provided.

The remote server may be configured via its processing system and computational engines to communicate with one or more applications distributed across a given geographical area. In some embodiments, the remote servers may cover a large geographical area such as by having multiple servers in communication across a large territory. The entity responsible for the server may make available, e.g., via an application download feature in a smart phone, an application that is specifically associated with the server. One or more prospective users of services may thereupon use the feature to download the application. In other configurations, the wireless device of the user may be selectively configured, e.g., by an information technology (IT) personnel member of a company (which may be the operator in some instances) to include an application that runs on a processor of the wireless device. The wireless device, in turn, may be configured to communicate with the server that includes the operator's formatted data parameters to allow the user access to use the service (e.g., the asset, function or facility) either upon presentation of a valid user identification provided by the application that matches a suitable data parameter, or where the service is subject to one or more predefined criteria included within the data parameters provided by the operator and provided by the server to the communicating application over the Internet. The criteria may include, for example, time, date, nature of use (of the service), number of uses, scope of user privileges, presence or absence of accounts allowing access, past restrictions, occupation of the user, identity of the user, etc.

In some embodiments, the criteria (e.g., the provided data parameters, whether or not formatted into an organized form by the server or employees of the third party) do not discriminate between levels of priority for different users, such that any individual can use the services, or use the services upon payment (also handled by the application and server, as described below). In other embodiments, the criteria may be grouped to partition different users having different access levels or types based on the different data parameters provided by the operator. These data parameters may associate a user identification to a particular set of privileges, for example. Some illustrations include allowing a group, such as police officers or medical technicians free access to a gated parking lot or to a vehicle charging station, while imposing a fee to other users not falling within the group.

As noted, conventional solutions to these techniques include, for instance, the need for a separate, dedicated electronic or optical access or fob, e.g., for accessing a restricted area, workout facility, back stage area, etc. This dedicated hardware becomes expensive, particularly as the number of applications in which regulations or property owners govern access grows. Moreover, it is generally easier to lose an access card, which typically includes hardware for a single function, than it is to lose a wireless device, which the user may keep track of for a number of different tasks. Further, in losing a card or key fob, these devices may be active for a relatively long period of time until the applicable system administrator is notified and is able to revoke access to the lost component. In the event a user loses his or her wireless device, conversely, the user can simply and quickly change the password online, for example, or report the device stolen, in which case quick action is usually taken to avoid fraudulent expenses.

The access cards and fobs are also less environmentally friendly. After typically being dedicated to one use for the duration of its life, the plastic cards and access devices are eventually discarded. In addition conventional techniques are less efficient. The techniques described above, however, integrate the key application functions into the user's preexisting wireless device, which may be capable of countless other tasks in a relatively small form factor that can be, and often is, recycled by the wireless carrier when a user upgrades a phone. The secure applications described herein can instead be used to provide greater overall flexibility for a corporation or other entity in controlling user access to services, which can include coffee-makers, lavatories, kitchen access, and the like.

Further, existing techniques for accessing services are often partitioned into multiple applications or functions by an operator, which adds complexity. By contrast, in the embodiments disclosed herein, the many services of an operator can be collectively provided in the form of data parameter sets, each potentially corresponding to a different service or access function, and provided to the third party remote server operator. In turn, the processing system of the server can integrate these functions into different services available to different classes of users that download the applications. In addition to mere payment, such as provided by ApplePay and those services like it, the data parameters granting or restricting access to specific users (or limiting access to a finite number of times or a finite duration) can be seamlessly integrated into the applications from the server. Where payment is necessary, such as in the case where the operator is a municipality that charges parking fees to regular users but allows police officers and other government personnel to park for free, user accounts may be easily established. In some embodiments, the applicants may be initially linked via the server connection to a credit or debit card, or a bank account, in which case the user can simply add credit to his or her account. The collected money may be distributed to the relevant subscribers by the controllers of the server, subject to any deduction for a simple subscription fee to the third party server controller.

Furthermore, user identification and service identification can be easily matched with the information in the repository pertaining to the data parameters. A set of unique user identifiers (IDs) may be assigned to a group of users associated with one operator, for example. Further, if the operator has a plurality of services, such as a multi-building landlord that runs a plurality of laundry machines present in different tenant buildings, the identification of the relevant laundry machine can be easily provided via the application to the server. One common way of providing the service ID is for the third party to provide and the operator to add a QR code provided by the third party and attached as part of an access element directly to the laundry machine. In other cases where a mechanism providing the service is out of reach, for instance, the QR code may be attached to any place convenient that is adjacent the expected area of the service or the user, or local to the relevant area. For purposes of this disclosure, the term access element may refer simply to the user identifier, including a QR code or another code type, affixed to the relevant vending machine or adjacent the user's window in a parking garage, as examples. The camera on the phone or other wireless device may be used to scan the QR code, which may provide the server (via the application over a network/Internet connection) with the identification of the service module at issue. The user's login information can, whether before or after the QR code or other information is scanned, be used to identify and authenticate the user at the server.

In lieu of a separate, potentially costly Internet accessible hardware payment module as is implemented to effect payment at the point of sale such as in existing access solutions, the application can instead take over the function of payment by simply deducting the appropriate amount of money from the user's account (e.g., established with the third party service operator), without the need for paper receipts and additional payment modules, the latter of which may also be subject to vandalism.

The user of indoor gated parking may be a tenant of the building, which in turn may be an authorized user of the parking service and as such is identified by the data parameters in the repository, as determined by the application. In this case, the server may return to the application, via the Internet or otherwise, an access code enabling the user automated access. Similarly, in the case of a vending machine, upon successful tender of payment based on the encoded (or predetermined) amount corresponding to the particular machine and stored in the repository (or identified on an access element of the machine with a price), the payment can be deducted from the user's account, thereby validating the sale and providing the vending machine with an access code provided from the data in the repository that matches a code stored in the machine.

In other embodiments, as is evident from the above examples, automated access (e.g., movement of a gate or sliding of a door in a vending machine to allow dispensing of a beverage or food article, or activation of a washing machine), may conventionally require that the machine's electronic or mechanical functions be overhauled to accommodate automated access after the user is validated by the data parameters and/or payment is tendered. In conventional cases, in addition to the separate internet module used for validating payment, a separate technology may have to be incorporated into the mechanism by the operator. By contrast, as shown below, in such devices where some electronic actuation is needed to raise the gate or complete another service, upon purchasing a subscription to the service, the operator, following instructions of the third party server personnel, can perform a simple retrofit. For example, in a laundry machine, tender of payment for a load is realized by a small module provided by the third party that may bypass the coin function and provide the necessary electrical signaling to activate the machine. The simple retrofit may be considered to be part of the access element for purposes of this disclosure. In other embodiments, the QR (or other) code may be located in a conspicuous place that is different from the retrofit circuit that activates upon receiving the access code from the application. For purposes of this disclosure, both the QR (or other) code and the retrofit device are considered to be part of the access element, whether or not they are proximate each other or connected to each other. The access element may also include a Bluetooth or other local network connection for enabling two way connections with the application via the Bluetooth or other local-network equipped wireless device (e.g., smartphone 118). At the access element, the Bluetooth may receive the access code from the application, and the application may receive confirmation from the access element, among other embodiment-specific information.

Thus, the use of the retrofit element which activates the electric motor on the parking gate, for instance, or which activates the vending machine or opens a locked door, is designed to work with the access code provided by the server to the application. This obviates the need for redesigning the relevant access terminal, gate or door to include a sophisticated mechanism for actuating a device. All that is required is instructions from the operator (such as wiring, voltages and currents) to operate the appropriate activation device, while the existing security mechanisms can remain on the device. The integrity of the security mechanisms remains in place, since they are left with the relevant device (door, etc.) and require a valid access code to be bypassed. This differs from conventional methods, which require a separate payment mechanism to interact with the device.

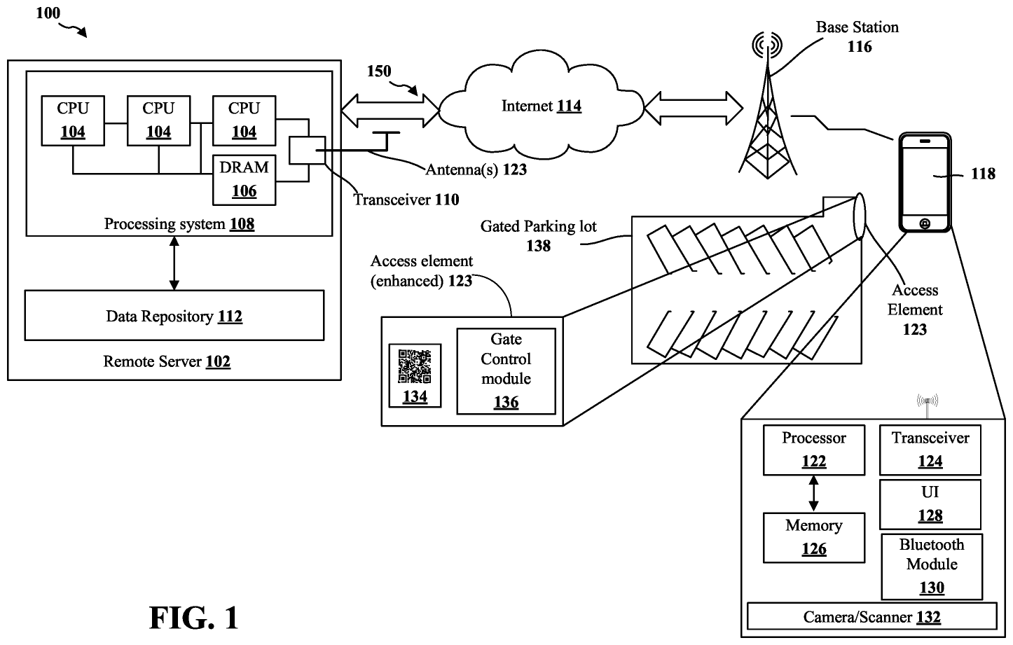

FIG. 1 is a block diagram 100 illustrating an exemplary embodiment of a server 102 to which an operator has subscribed and a service including an access element 123 for enabling a wireless device user to access a service with the assistance of an application loaded onto the wireless device from the server 102. The server 102, which may be at a remote location from the service region, may include a processing system 108. The processing system may, in turn, include a plurality of CPUs 104 and memory such as DRAM 106 which may include cache memory for fast retrievals of recently-used data parameters. The processing system in this embodiment also includes transceiver 110, which may be wired or wireless, but in this case is shown as coupled to antenna(s). Also shown is a hardwired connection represented by arrow 150 to and from the server 102 and Internet 114. Data may be transferred between remote wireless device, e.g., via base station 116 to smartphone 118. The server 102 also includes data repository 112 in which data from particular operators may be stored for use in determining the scope of user rights in accessing any given operator-promoted service.

It will be appreciated that FIG. 1 is not drawn to scale, but rather different elements are shown in different sizes to clearly identify the mechanical systems involved. It should also be understood that the physical constitution of the processing system 108 and data repository 112 may vary widely. For example, the third party may own more than one server, with each server having a different architecture and using one or more processors. The data repository 112 may also have different forms, and may include one or a few storage drives in several different areas, or a single, large array of drives in one or two areas. In short, the various elements of remote server 102 may differ depending on a number of factors, including the selections made by the third party server controller.

With continued reference to FIG. 1, a user (such as a building tenant that wants to use the advertised laundry machines or a driver that wants to use a specific toll lane on a municipal freeway, etc.) may download a version of the application over the internet 114. The application may be stored at the server 102, or it may be located at another area, e.g., accessible to an android or iOS application download tool on a smartphone or other wireless device. Once the application is downloaded, the user may provide login credentials and personal information sufficient to identify the user for the desired service, or plurality of services, at issue. If the user ID includes an employee ID, for example, that information may be provided by the operator to the data repository at the initial time the operator subscribes to the third party's service. That way the processing system 108 can readily identify uploaded user IDs, after performing any decoding or decrypting techniques that may be used with the application and that are well known in the art.

In the example of FIG. 1 in which the user is an employee ID, the operator or owner of the lot may (or the employer, depending often on the owner of the lot or the dedicated caretaker) may provide the user IDs when subscribing over their own version of the application (which may be a desktop application, for example). After or concurrent with acquisition of the subscription, the third party may send a technician to the service area (here, the gated employee parking lot 138) and may install as part of the access element 123 located adjacent the driver side window a sticker with a QR code. The technician may also provide a module with wires for receiving an access code from a Bluetooth or other local network. The access element 123 may also include a two-way Bluetooth module or other local network module for exchanging information with the wireless device.

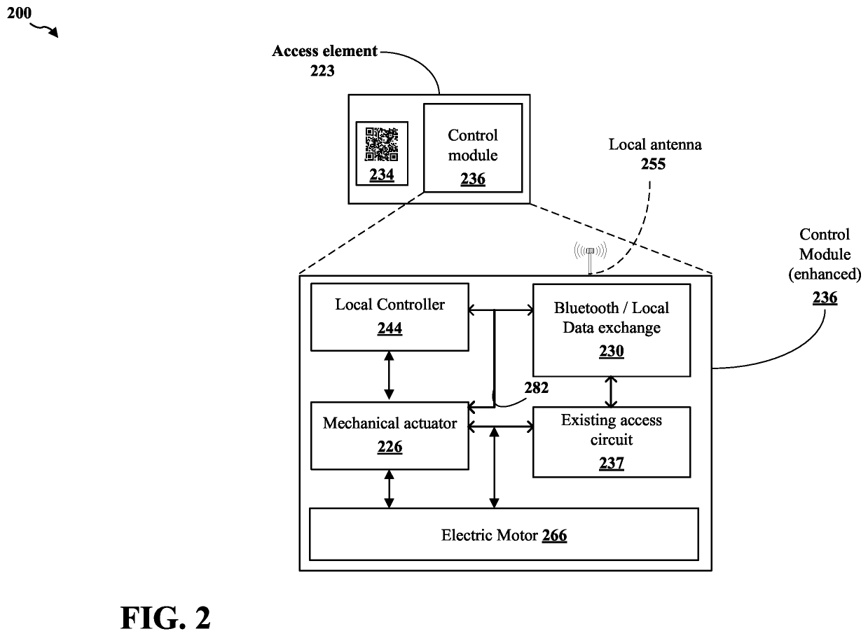

FIG. 2 is a block diagram which in this embodiment includes a QR code and a control module for providing data to a wireless device used for accessing a service via an access element. As noted above, for purposes of this disclosure, the access element 223 may include a QR code 234 and a control module 236. However, these two components of the access element may be connected as shown, or they may be distributed in different regions. In the gated entryway example, the access code may conveniently be adjacent the driver's window along with the Bluetooth circuit 230, while the remainder of the control module 236 may be closer (or integrated with) the mechanical assembly of the gate. It should also be noted that in this example, only a small portion of the total elements of the control module 236 are attributable to the third party or the operator.

For example, a vending machine or gated parking, or an electronic door may typically include a preexisting electric motor 266 that opens the gate or that initiates the delivery of a vend, and an existing access circuit 237 that may open the gate upon receipt of conventional methods like access cards or payment via an Internet payment authorization module, an employee, etc. In this example, the third party has simply retrofit within the gate or other machine a mechanical actuator which is wired per the operator's instructions to activate the electric motor 266 upon receipt by the Bluetooth or local data exchange (network) mechanism 230 of a valid authorization code from the application on the wireless device (not shown). Typically, the local controller 244 in the control module may be some microcontroller or other hardware based device (digital signal processor (DSP), application-specific integrated circuit (ASIC), field programmable gate array (FPGA), RISC processor, or the like which controls the access circuits and other electro-mechanical elements. The Bluetooth or other local network device may also include a two-way local antenna 255 for exchanging information at the point-of-service or point-of-sale with the wireless device.

The QR code 234 in FIG. 2 may be used to provide the identifier for the particular service element and/or operator. That information can be provided by the mobile application to the server so that the server can extract the appropriate data parameters relevant to the operator's subscription.

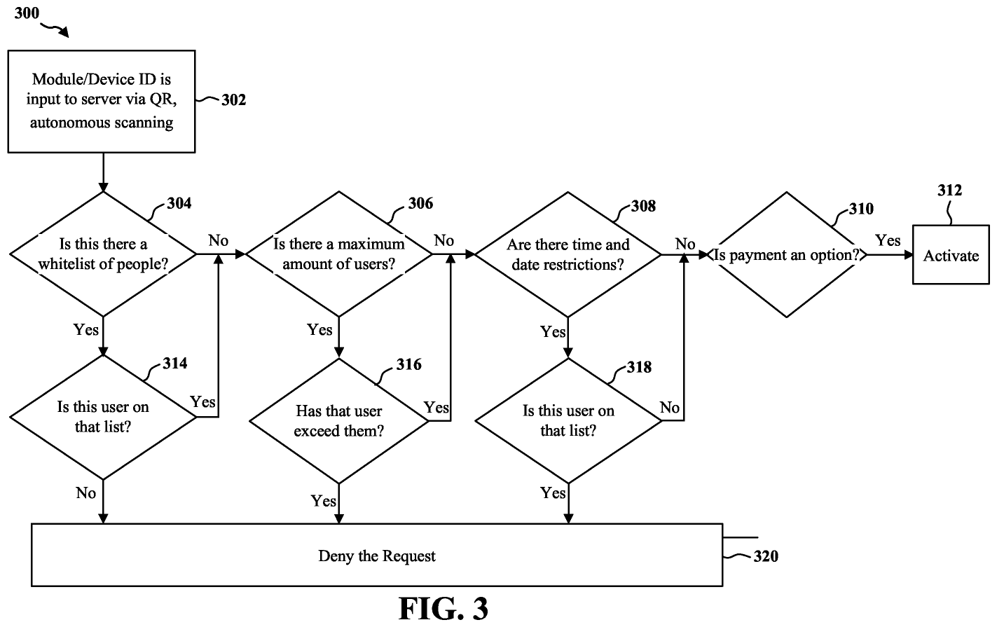

FIG. 3 is a flow diagram 300 illustrating techniques for accessing a service by a subscriber based on data parameters provided by the operator of a service to the remote. As noted, the application can be used to provide a large number of different types of services to any given user. For many applications that interest operators/subscribers to the data repository, an automated service can be made available (including but not limited to those described above) in exchange for simple payment. In other cases, however, the operator needs for flexibility. For example, the operator's service may not be limited to one-time payments. Some users may be given options to use a given service, or similar such services, for a predetermined number of times as an incentive to make another deal with a user, for example. Still other subscribers may require a list of people which can use a service for free, with the remaining users requiring payment to use the service. For others, such as employees of municipalities, time and date restrictions may become relevant. Also, particularly important in connection with various services such as admission to an art gallery or other semi-public establishment, or parking, is a maximum number of users. Advantageously, the principles of the present disclosure allow these types of data and others to be stored for a subscriber in the data repository. The application, upon providing the appropriate user/service identifier to the server, may then retrieve a message from the server indicating the user's remaining rights (if any), with respect to the service. Thus the server may grant a payment free access code for a particular service if certain criteria are met, as governed by the data parameters placed in the repository on setup of the subscriber account (or as later provided).

With specific reference to FIG. 3, at block 302, the module or device ID may be provided to the server via a QR code using the camera of the wireless device, or via another form of autonomous scanning, such as by manually inserting an alphanumeric code that is at the point-of-service. This information is provided by the processor of the wireless device in executing the application layer back to the server. Responsive to receiving the information, the server may identify all applicable criteria in the data repository that apply to this user for this service, if any. In this example, responsive to the device ID, the server may query whether the repository includes data parameters identifying a whitelist of people at diamond 304. A whitelist of people, as noted, may correspond to employees at a facility who have free parking, The processing system at the server may then query whether the user is on the whitelist at diamond 314. If there exists a whitelist (304) but the user is not on the list, the server can issue a denial of the request (320) to the mobile application. If either there exists no whitelist or the user is not on the list, then the processing system may execute the next query, such as whether the service has accommodated a maximum amount of users or uses. If so, and the user has exceeded them, then the server may issue a denial of the request to the wireless device via the mobile application (320).

As another example, with respect to diamond 308 and assuming there is not a maximum amount of users or uses reached, the server may query the repository to determine whether data parameters provide any time or date restrictions. If there are, then the processing system at the server may review the time and date relative to the time and date information provided by the wireless device (if necessary). If the user is subject to one or more time or date restrictions and the restrictions apply, then the server may again deny the request (320). It should be noted that numerous other types of data parameters may be applicable, such as number of times the service is used, amount of articles (e.g. food, beverages or other amenities) taken has exceeded a threshold, etc.

In the case of FIG. 3, if no time and date restrictions apply or they do apply but do not restrict the user entirely, then the processing system may enquire if payment is one of the data parameters that is a viable option for the user. If payment is an option, the server may message the mobile application that the user has the option of deducting payment from his or her account to access the service, and if so, the service is activated (312)

As the above examples illustrate, access control can allow the customers/subscribers of the third party server operator to control access to a module/device identifiable in the server to control access to a module/device via time/date parameters, a list of accounts/people who can gain entry, payments, and/or limit usage (such as allowing a user to use a service three times daily). These techniques can be used as stand alone data parameters identified for individuals, or they can be used for groups of users. As noted, one group of people may be whitelisted, while the application instead may requires another group to pay. Among the other advantages, the concepts herein provide greater security in that a user can instantly disable an existing wireless device by changing their password or contacting their carrier should they lose their smart phone. By contrast, a lost card may not be noticed, and an be active for a long time until an administrator of the system revokes access. The use of the wireless device is also more environmentally friendly than the fobs and the cards, the latter of which are physical plastic objects that need to be produced. The server model is also more efficient for at least the reasons set forth above. For example, the operators can consolidate all of their services at the server into a single, or at most a few, subscriptions depending on the types of services at issue. This in turn leads to lower operational costs for organizations. The requirement of a corporation to distribute hundreds or thousands of cards is obviated, as all access is now granted virtually via applications on respective user and server sides as dictated by the data parameters provided by the operator.

In another aspect of the disclosure, techniques and devices are disclosed for providing offline access where there is no internet capability on either side, whether to commence payments or to access the server via the wireless device. Conventionally, where there is no Internet accessibility, a pay terminal can be faced with a situation which prevents it from functioning, thus precluding access to the service altogether.

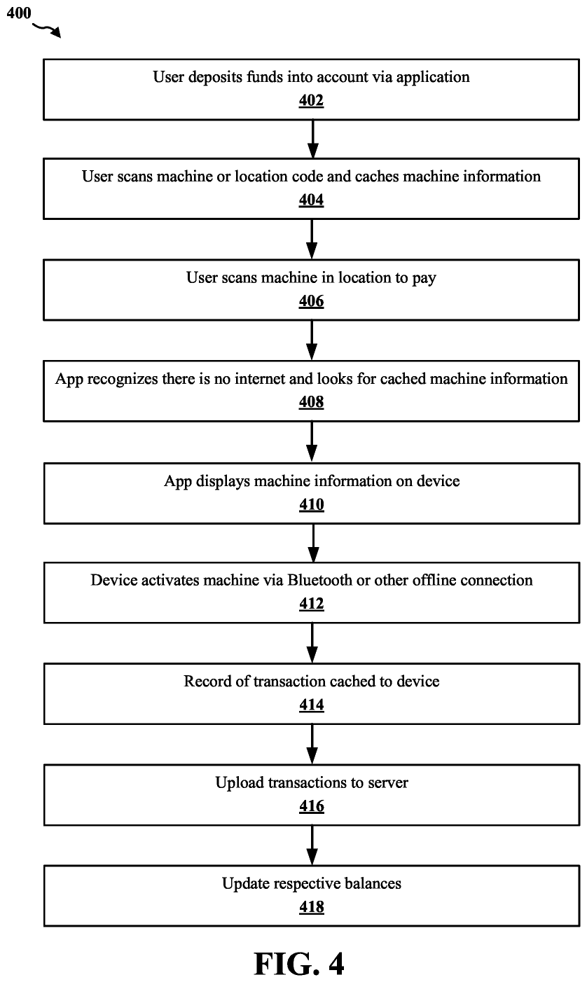

FIG. 4 is another embodiment 400, a flow diagram allowing a user to use a previously downloaded application to obtain offline access to a paid service in accordance with another embodiment. At block 402, when the Internet is functioning normally, the user deposits funds into his or her account using the mobile application. At block 404, where it is assumed that the user desires to use a service, the user may scan the machine or location code and caches the machine information, as discussed with reference to various examples, above.

At 406, the user scans the machine in the location to pay. At that time, the mobile application in the wireless service recognizes that there is no internet access and consequently looks for the cached machine information, as in block 408. At block 410, the application may display to the user the available machine information on the device based on the earlier scan. At block 412, the wireless device may activate the machine via Bluetooth or a similar wireless connection that is local to the immediate region of the machine. At this point, the activation of the machine enables the user to access the server If the machine were a remote gateway, the gateway underground, the gateway may open.

At 412, a record of the transaction may be locally cached to the wireless device. At some possibly subsequent time, once the mobile application recognizes that Internet service is again available, the mobile application may upload the prior cached transaction(s) to the server. At the server in block 418, the respective balances of the parties account are updated to reflect the transaction. Information may also be provided to modify any of the data parameters based on the transaction, if necessary.

The reliance of existing methods on Internet connected payment methods means that the associated service that uses those methods may be shut down until Internet service returns. With the principles enumerated above, this loss of service can be avoided altogether, realizing additional revenue for the operator.

As referenced above, upon initiating an initial subscription to the third at a time when the access is initially being established, the remote server may facilitate the initiation process with a subscriber by providing, in this example via a desktop version of the application. For example, when the operator is initially accessing the application to enter the user information pertaining to the services that the user wants to automate, the remote server third party may respond to prompts from the operator to establish a new implementation of servers by a group of users.

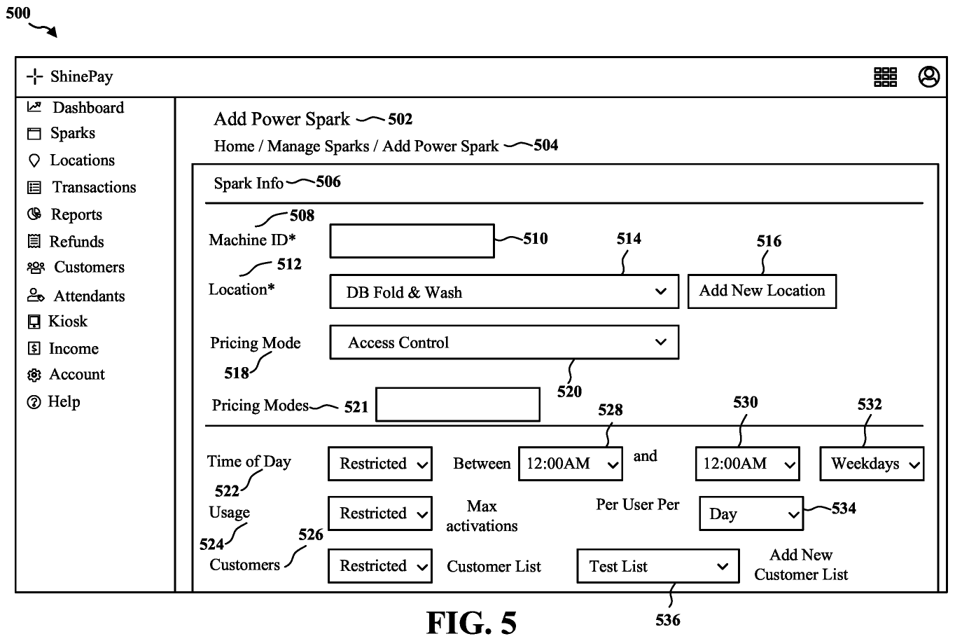

To this end, FIG. 5 is an exemplary touch screen 500 of third party server-provided software for entering data parameters in accordance with an embodiment. In this case, rather than being provided to the user, the template fill-in screen may be supplied to a prospective or existing subscriber for opening access to a new set of services that may be distributed across a geographical reason. The provided web page to the operator may include a plurality of options on the far left column, each of which brings up a different set of categories. Referring to the “Add Power Spark” 502 language, the operator may see that he or she is at a directory 504 under “manage sparks” in which operator can add a new service and set of access elements corresponding to that service. Clicking on link “spark info” 506 may allow the operator to insert data parameters corresponding to one or more services and users of the new service.

A machine ID 508 such as “washer” or “dryer” along with any necessary identifying information may be entered by the operator in field 510. The operator may select, with greater particularity, the nature of the service. For example an external vendor fold and wash may be selected amongst a drop-down list of possible selections at 514. The application may further prompt the user to provide a new location of the machine, to be inserted in field 516. Data parameters such as a Pricing Mode 518 may be provided to provide yet additional information on the nature of the service. Different pricing modes such as “access control” selected by the operator in drop-down menu 520 may made available.

Further data parameters may be made available to the operator to circumscribe further the scope of intended or allowable use of the service. An additional pricing mode information field 521 may be provided. Other data parameters regarding the service enumerated above, including time of day 522, usage 524, and customers 526. At the subscriber's option, the three options may be further restricted, with different allowable scopes of use imposed. In the case of time of day 522. the operator may determine the available times of the service by manipulating the drop down menus 528 and 530 for the time range, and menu 532 for the day range, currently set on “day” but which also include other selections such as hour, minute, and week, depending on the type of service.

In addition, a customers' criterion 526 may be available to provide further data parameters regarding potential restrictions on access to the service by customers. A drop down list 536 may include a test list, which may be a list provided in another screen of parameters to the third party server. Lists may include names of individuals, for example, or other identifying parameters such as for people in law enforcement, and other individuals.

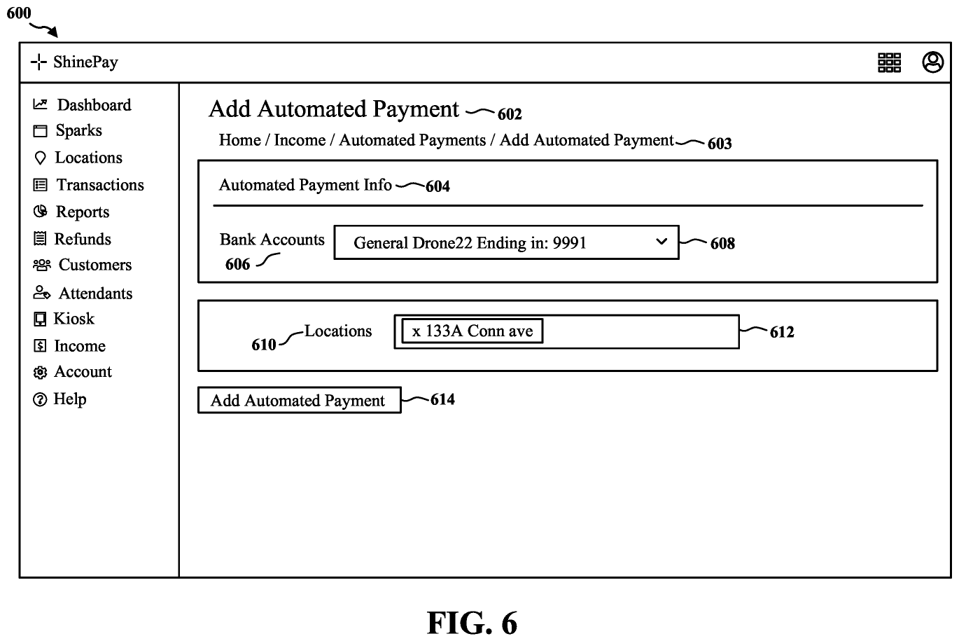

FIG. 6 is another exemplary touch screen 600 of third party server-provided software 600 for entering data parameters in accordance with an embodiment. The dialogue box or web page 600 is construed similarly as the one in FIG. 5. In this case, data parameters are provided to enable an operator to allow its respective users of one or more services to add an automated payment, as shown in 602. It will be appreciated that the mobile application may include a similar screen enabling the user of the service to enter one or more forms of payment. At “Add Automated Payment” 602, the operator can see that the directory listing shows a number of categories of data parameters that may have been input. Field 604 enables the operator to add the acceptable automate payment information. The identity of bank account corresponding entered by a specific user in the mobile application may be specified, including the example bank and last four digits of the user's account in field 608, which may encompass, for example, the user's checking account at the identified branch. Field 610 labeled “locations” may include an address of the financial institution(s) through which payment credit can be added to a user account 612. The button “Add Automated Payment” 614 may enable the operator to specify additional payments made by users at their respective mobile applications. It is noteworthy that a similar field may be provided to the user at the mobile application, enabling the user to set up a financial account with funding provided from a specific source.

FIGS. 5 and 6 are merely exemplary in nature for enabling operators to provide various data parameters. Other operator/subscriber based applications may be equally suitable, and other types of restrictions and data parameters may apply to different services.

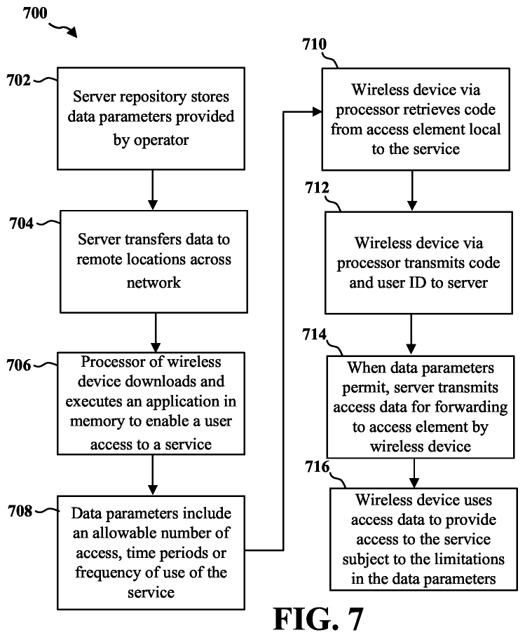

FIG. 7 is a flow chart 700 illustrating a method according to an exemplary embodiment. The methods of claim 7 may be performed by the server and the wireless device. At block 702, the data repository at the server stores data parameters provided by the operator, as demonstrated in the various examples above. It will be appreciated from this disclosure that the number of data parameters can increase (or differ) to well beyond the scope of those mentioned herein, depending on the nature of the service, among other things. Referring to the block at 704, the server may be configured to transfer data to wireless devices at remote locations across the network or the coverage area, if any, as defined by the server. Thus, for example, users of wireless devices may request downloads of the application, or they may request financial transactions to use various services, and the server may respond by responding with appropriate data to those locations after the processing system evaluates the request, authenticates the request, and provides an appropriate response.

More specifically, as shown at block 706, the processor within the wireless device may download, via the transceiver and antenna of the wireless device, the mobile application, the latter of which the processor may execute the newly downloaded code stored in memory and respond to the upcoming screens on the wireless device to enable the user to access a particular service governed by the application.

Thereupon, at the block shown as 708, the data parameters in this example may include restrictions on the service such as an allowable number of accesses per time period, an allowable total access time period, or an allowable frequency of use of the service. This information and possibly other data parameters may be evaluated at the server to determine the user's scope of rights to the service. In some cases, this step may occur at a different time, such as, for example, after 710 or after 712.

With reference to the block at 710, the wireless device may, via the processor using the camera, retrieve a code such as a QR code from the access element or sticker provided by the third party and placed on or near the service provider device by the operator. The code portion of the access element is local to the service such that it can be conspicuously identified by the user. By contrast, the retrofit module installed, e.g., by the operator and provided by the server third party may also be local to the service, but may be unseen if it is retrofit with internal circuitry of the service providing machine.

At block 714, and when the data parameters at the server indicate that access is permissible for this user and this service ID, the server may transmit access data, such as an access code. The access code may be forwarded by the mobile application via the Bluetooth or another local network module on the wireless device to the access element. Upon receiving the correct code, the wireless device at block 716 uses the access code/access data to provide the user with access to the service. If so dictated by the data parameters described in block 708, the access to the service may be subject to the limitations of the data parameters, which may be updated according to the behavior of the user. For example, where the access device is coupled to heat and activate a jacuzzi and the data parameters indicate that the user has ten minutes of free use left, the jacuzzi may be disabled after ten minutes, unless the user has an option to charge for more time and does so.

Offline payments can allow payments to take place even where there is no Internet connectivity. As noted above, prior to entering an area that is deprived of Wi-Fi, cellular, or other means of communication to the Internet, the user funds an account with the wireless device, thereby causing a given amount of funds to be cached with the wireless device for contemplating such use. The amount destined from the cache may be deducted and stored locally. When the user of the wireless device enters information in the application seeking to use a service, a preconfigured amount corresponding to the service may be deducted from the user's cached account and stored locally with appropriate encryption. Once the wireless device returns to a region of active Internet service, records of the transaction that was taken absent the Internet can be uploaded to server, which in turn initiates a refund to the customer to credit the users' balance, where the balance is synchronized on the server and database.

From the above example, one significant advantage of the offline payment method can be seen. Aside from allowing services to be rendered without the need for an Internet connection, the amounts deducted from the user's cached account can be chosen such that the likelihood of receiving a credit due to a deduction is high. In turn, when the wireless device returns to a region of Internet accessibility, the user receives a credit rather than a debit from his or her existing balance. The use of this credit provides an incentive for the user to return the wireless device unscathed, and discourages losing, damaging, or otherwise disactivating the phone, lest the user lose the benefit of the credit.

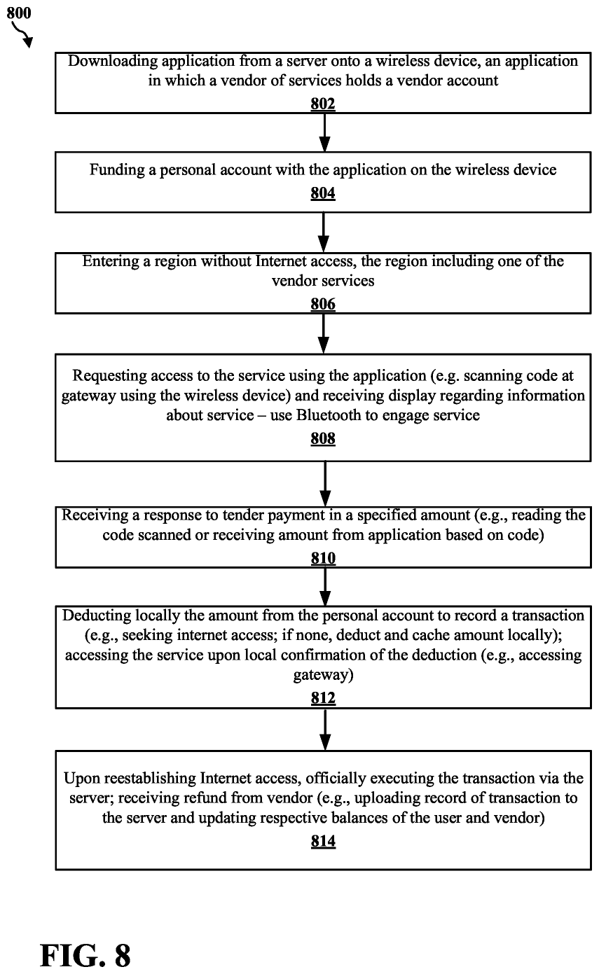

FIG. 8 is a flow chart 800 illustrating a method according to an embodiment. The method described in FIG. 8 is generally performed by the wireless device, along with its constituent elements (processor, memory, and the like). Referring initially to block 802, the wireless device may first download the application from a server (or one of several related servers) onto the user's smart phone or other wireless device. The operator or, in this case, the vendor of the service holds an account with the third party server operators.

At block 804, the user may proceed to fund an account using the mobile application on the wireless device. At block 806, the user may leave an area having Internet access, and enter another region which includes a vendor service but which, for whatever reason, is blocked from Internet access. At block 808, upon identifying a desired service which is compatible with the mobile application, the user via the wireless device may request access to the service via the mobile application. Such request may include scanning the code at the gateway or access element using the camera of the wireless device under the control of the processor and receiving from the mobile display a screen showing information about the service, or the category thereof as stored in the wireless device based on the data parameters (along with other services, if applicable, that service the wireless device) before the wireless device went out of range. Thereafter, the wireless device may use Bluetooth or another local two-way wireless service to contact the access element locally with this information.

Thereafter, at block 810, the access element having received the local transmission, may respond to the wireless device. The wireless device may receive a response to tender payment in a specified amount, as described above. The specified amount may be a preconfigured amount known by the access element or read from the Bluetooth or other local transmission from the application. The cost for the service may also be embedded in the QR code, although in some embodiments the cost for the service in the absence of Internet is higher in order to motivate the wireless device holder to return the wireless device to Internet access and retrieve the refund.

When, such as shown at block 812, the wireless device using the application performs a local deduction as authorized by the user to deduct a portion of the locally cached funds if no internet access is available. Thereupon, the user may access the service upon local confirmation of the deduction and contacting the access element to access the gateway.

At block 814, when the wireless device reenters an area where internet access is again available, if necessary, the server or financial institution acting in concert may officially deduct execute the transaction. In the embodiment above, the deduction may entail refunding a sum deducted locally from the vendor's account. At this point, the user is reimbursed for any excess payment made for use of the service, and the remaining amount used for the service is deducted from the user's balance.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) in the United States, or an analogous statute or rule of law in another jurisdiction, unless the element is expressly recited using the phrase “means for” or, in the case of a method claim, the element is recited using the phrase “step for.”

What is claimed is:

1. A system, comprising:
a server coupled to a repository for storing data parameters provided by an operator, the server being networked for transferring data to remote locations; and
a wireless device comprising a memory and a processor configured to execute an application stored in the memory to enable a user to access a service, an allowable number of accesses, or time periods or frequency of use of the service based on the data parameters; wherein:
the processor is configured to retrieve a code from an access element local to the service, and transmit the code and a user identification (ID) to the server;
the server is configured to compare the data parameters with the code and user ID;
when the data parameters permit, the server is configured to transmit access data for forwarding to the access element by the wireless device; and
the wireless device is configured to use the access data to provide access to the service, the scope of service subject to the data parameters maintained in the repository.

2. The system of claim 1, wherein:
the data parameters indicate that access to the service for the identified user includes one or more restrictions corresponding to one of (i) a scope of use or restriction of frequency of uses, (ii) a list of allowed users, (iii) time or date restrictions, or (iv) payment; and
the processor is configured to authorize the service only subject to the one or more restrictions imposed on a use thereof by the user, and otherwise to deny the access.

3. The system of claim 1, wherein when the data parameters indicate that the access to the service is payment-based, the access data provided to the wireless devices authorizing access to the service conditioned upon the user tendering a specified payment via a user account established with the application.

4. The system of claim 1, wherein after the access to the service, the processor via the application is configured to transmit updated information to the server for updating the data parameters relevant to the user.

5. The system of claim 1, wherein the data parameters comprise one or more of a user identification, one or more allowable time ranges of use, one or more allowable dates of use, a maximum duration of use, a maximum frequency of use, a list of authorized users, or special status or occupation of the use, or a discount to which the user is entitled.

6. The system of claim 1, wherein the service comprises electrical vehicle charging, a parking lot, or an access gate.

7. The system of claim 1, wherein the access element comprises one of a QR code, a Bluetooth receiver retrofit by the operator for actuating a motor, or other local network connection in which data corresponding to authorization from the wireless device are conveyed between the application and an actuator provided by the operator.

8. The system of claim 7, wherein the access element is retrofit with a circuit configured to receive a signal from the wireless device to authorize service upon the user tendering payment via a user account established with the application, and to initiate access to the service based on the authorization.

9. The system of claim 1, wherein the service comprises a vending machine and the access element is retrofit by the operator to the service.

10. A wireless device, comprising:
memory; and
at least one processor coupled to the memory and configured to:
execute instructions from an application stored in memory to provide a user interface (UI), the UI for providing a user access to a service maintained by a third party, wherein access rights of the user are maintained based on data parameters provided by the operator and stored by a third party in a repository;
transmit, via the UI to a remote server coupled to the repository, at least one message requesting access to the service and an identification thereof;
receive from the server information comprising an authorization to access the service, the authorization being subject to restrictions to access the service if present in the data parameters;
enable the user to tender a payment from an account established using the application if the authorization is conditioned on payment; and
based on the at least one of the authorization information or the payment confirmation, enable the user to access the service,
wherein the access element is local to the service and uses a single local network connection from the wireless device for actuating an access mechanism to the service.

11. The device of claim 10, wherein:
the access by the user is subject to one or more of the restrictions; and
the at least one processor is configured to:
authorize the user to access the service subject to the restrictions; and
transmit to the server, after use of the service, data corresponding to the use for updating the data parameters at the server.

12. The device of claim 10, wherein the at least one processor is further configured to match at least a portion of the authorization information, or data derived therefrom, with a QR code affixed to or adjacent an access element local to the service or a gateway providing the service.

13. The device of claim 11, wherein the access element is coupled to or affixed on the service or a device providing the service and is configured to initiated user access to the service based on a local network command from the wireless device, the command originating from the server.

14. The device of claim 13, wherein the access element comprises a QR code for scanning by a camera on the wireless device using the application and for providing to the server.

15. A non-transitory computer-readable medium storing computer executable code, the code when executed by a processor of a wireless device, causes the processor to:
provide a user interface (UI), the UI for providing user access to a service maintained by a third party, wherein access rights of the user are maintained based on data parameters provided by the operator and stored by a third party in a repository;
scan, via the wireless device, a device identification;
transmit, via the UI to a remote server coupled to the repository, at least one message requesting access to the service, the at least one message including the device identification and an identification of a user;
receive a response from the server, the response authorizing the user to access the server, the response including any applicable restrictions;
when one or more restrictions apply, authorize the user access to the service subject to the restrictions via a local network transmission to an access element corresponding to the service; and
wherein the access element does not require an Internet connection.

16. The computer readable medium of claim 15, wherein the code causes the processor to:
determine whether payment in exchange for the access is an option;
if payment is an option, enable the user to tender payment via a user account established with the application;
if payment is not an option, determine whether another access option exists;
otherwise, deny the access.

17. The computer readable medium of claim 15, wherein the code causes the processor to:
determine whether a maximum number of uses exists;
when a maximum number of uses exists, determine from the data parameters at the third party repository whether the user has exceeded the number;
when the user has exceeded the number, determine whether another access option exists;
otherwise, deny the access.

18. The computer readable medium of claim 15. wherein the code causes the processor to:
determine whether any time or date restrictions exist as applied to use of the service;
where time or data restrictions are present, determine whether the user has exceeded the restrictions based on the data parameters at the server;
when the user has exceeded the restrictions, deny the access.

19. The computer readable medium of claim 18, wherein the device identification comprises a QR code affixed on or part of the access element.

20. The computer readable medium of claim 19, wherein the service comprises a gate or parking entrance.
